(19) United States
(12) Patent Application Publication
(10) Pub. No.: US 2025/0117541 A1
(43) Pub. Date: Apr. 10, 2025

(54) METHOD AND APPARATUS FOR MEASURING AND CALCULATING FULL LIFE CYCLE CARBON EMISSION EQUIVALENT OF POWER BATTERY, AND MEDIUM

(71) Applicant: BEIJING NATIONAL NEW ENERGY VEHICLE TECHNOLOGY INNOVATION CENTER CO. , LTD., Beijing (CN)

(72) Inventors: Feng DU, Beijing (CN); Xi WANG, Beijing (CN); Lei ZONG, Beijing (CN); Chengyin YUAN, Beijing (CN)

(21) Appl. No.: 18/695,918

(22) PCT Filed: Jun. 10, 2022
(86) PCT No.: PCT/CN2022/097987

§ 371 Date: Mar. 27, 2024

(30) Foreign Application Priority Data
Oct. 11, 2021 (CN) 202111183683.5

(51) Int. Cl. G06F 30/20; G06F 111/10

(52) U.S. Cl. CPC G06F 30/20; G06F 2111/10

(57) ABSTRACT

A method and apparatus for measuring and calculating a full life cycle carbon emission equivalent of a power battery, and medium. The method comprising: acquiring a first carbon emission equivalent of a raw material acquisition stage of a power battery; acquiring a second carbon emission equivalent of a production stage of the power battery; acquiring a third carbon emission equivalent of a usage stage of the power battery; acquiring a fourth carbon emission equivalent of a cascading utilization stage and a regeneration stage of the power battery; measuring and calculating the full life cycle carbon emission equivalent of the power battery on the basis of the first carbon emission equivalent, the second carbon emission equivalent, the third carbon emission equivalent, and the fourth carbon emission equivalent. According to the method for measuring and calculating a full life cycle carbon emission equivalent of a power battery of the present disclosure, the carbon emission equivalent in each link of the full life cycle of the power battery is collected, a carbon emission value in the full life cycle is obtained, and the effect on carbon emission of fabrication and regeneration process routes is taken into account. In one aspect, coverage content is relatively comprehensive, and in another aspect, the present disclosure is closer to the actual process, and data obtained from calculations are more reliable.

### FIELD OF TECHNOLOGY

The present disclosure belongs to the technical field of carbon emission, and more specifically relates to a method and apparatus for measuring and calculating a full life cycle carbon emission equivalent of a power battery, medium and an electronic equipment.

### BACKGROUND

The dual-carbon plan has become a legal commitment and a political strategy, and its importance is self-evident: it not only means that the process of the energy revolution will be accelerated on a global scale, but it will also start a new round of industrial revolution. A wave of zero-carbon economy that will last for 20-30 years and will have a profound impact on the world has begun. In this wave of zero-carbon economy, the power battery industry, as the intersection of the three major fields of energy, transportation and industry, not only plays the role of the pioneer of the carbon neutral revolution, but also plays the role of “being revolutionized”. Therefore, it has become the focus of attention from the perspective of carbon neutrality. With the rapid growth of power battery production capacity and volume, a large amount of carbon emission will be generated in the production process of power batteries and upstream and downstream industrial chains. As an important component of carbon emission in the entire life cycle of electric vehicles, the carbon emission of power batteries has become a core concern in the transportation field. As a major power battery manufacturing country, the country conducts research on carbon emission in the life cycle of power batteries and promotes carbon emission reduction in the life cycle of power batteries. Therefore, the measurement and calculation of carbon emission equivalents has significant value and meaning for the development of low-carbon logistics and the coordinated development of the economy, society and the environment. The measurement and calculation of the carbon emission equivalent is a widespread technical problem, and there are many methods for measuring and calculating the carbon emission equivalent commonly used at present.

The patent document (CN105260836A) discloses a carbon emission collection and accounting system for automobile manufacturing enterprises, including a basic energy consumption data collection module, a carbon emission measurement module, a data query module, a real-time monitoring module, a statistics and analysis module and a report and report form generation module; The system can collect and calculate the carbon emission of an automobile manufacturing enterprise, and reflect the carbon emission of an automobile manufacturing enterprise in real time. The patent document (CN105138832B) provides a method and system for measuring and calculating carbon emission in vehicle route planning. The method includes: initializing relevant parameters for carbon emission calculation; establishing a vehicle fuel consumption model according to the relevant parameters, and according to the fuel consumption model establishes a carbon emission model; according to the carbon emission model, the carbon emission of the vehicle on the sub-path is obtained. The patent document (CN105574339A) discloses a carbon emission calculation method for dismantling of decommissioned passenger cars, which is characterized by first calculating the sum of dismantling energy consumption of connection features according to the dismantling sequence; then calculating the total amount of dismantled carbon emission based on the type of energy consumed by dismantling the connection characteristics; then calculating the redundant carbon emission caused by the environmental impact of dismantling; and finally obtaining the total carbon emissions of the entire dismantling process.

In summary, there are relatively many calculation methods for carbon emission equivalents at the vehicle level, but the calculation methods for the full life cycle carbon emissions of key components such as power batteries have not been reported.

Therefore, there is a special need for a general method for calculating the carbon emission equivalent of the full life cycle of the power battery, so as to provide more accurate and detailed calculation basis and basic data for the carbon emission assessment of the vehicle.

### SUMMARY

The purpose of the present disclosure is to propose a general method for calculating a full life cycle carbon emission equivalent of a power battery.

To realize the above purpose, the present disclosure provides a method for measuring and calculating a full life cycle carbon emission equivalent of a power battery, comprising: acquiring a first carbon emission equivalent of a raw material acquisition stage of a power battery; acquiring a second carbon emission equivalent of a production stage of the power battery; acquiring a third carbon emission equivalent of a usage stage of the power battery; acquiring a fourth carbon emission equivalent of a cascading utilization stage and a regeneration stage of the power battery; measuring and calculating the full life cycle carbon emission equivalent of the power battery on the basis of the first carbon emission equivalent, the second carbon emission equivalent, the third carbon emission equivalent, and the fourth carbon emission equivalent.

Preferably, the first carbon emission equivalent is calculated by the following formula:

$$Em 1 = \sum ECm 1 i * k 1 i + \sum Tm 1 i * k 2 i \qquad ( 2 )$$

wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

Preferably, the second carbon emission equivalent is acquired by the following steps: according to a process flow, the production stage of the power battery is divided into an electrode preparation stage, an assembly stage, a formation and grading stage, a grouping stage, and an integration stage; acquiring carbon emission equivalents of the electrode preparation stage, the assembly stage, the formation and grading stage, the grouping stage, and the integration stage respectively; acquiring the second carbon emission equivalent based on the carbon emission equivalents of the electrode preparation stage, the assembly stage, the formation and grading stage, the grouping stage, the integration stage and a carbon emission equivalent produced in transportation.

Preferably, the second carbon emission equivalent is calculated by the following formula:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value in the formation and grading stage; EMm2 is an energy consumption value of the grouping stage; ENm2 is an energy consumption value in the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

Preferably, the third carbon emission equivalent is calculated by the following formula:

Em3=EKm3*k5
wherein Em3 is the third carbon emission equivalent, EKm3 is an energy consumption value in usage of the power battery; k5 is a carbon emission equivalent coefficient of 1 kilowatt-hour of electricity in usage of the power battery.

Preferably, the fourth carbon emission equivalent is calculated by the following formula:

$$Em 4 = EPm 4 * k 6 + ETm 4 * k 7 + Tm 3 * k 8$$

wherein Em4 is the fourth carbon emission equivalent, EPm4 is an energy consumption value of the cascading utilization stage of the power battery; k6 is a carbon emission equivalent coefficient of using 1 kilowatt-hour of electricity of the cascading utilization stage of the power battery; ETm4 is an energy consumption value of the regeneration stage of the power battery; k7 is a carbon emission equivalent coefficient of using 1 kilowatt-hour of electricity of regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

Preferably, the full life cycle carbon emission equivalent of the power battery is calculated by the following formula:

$$Em = Em 1 + Em 2 + Em 3 + Em 4$$

wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

The present disclosure also provides an electronic equipment, wherein the electronic equipment comprising: a memory, storing executable instructions; a processor, the processor runs the executable instructions in the memory, so as to realize the method for measuring and calculating a full life cycle carbon emission equivalent of a power battery.

The present disclosure also provides a computer readable storage medium, wherein the computer-readable storage medium stores a computer program, and when the computer program is executed by a processor, the method for measuring and calculating a full life cycle carbon emission equivalent of a power battery is realized.

The present disclosure also provides an apparatus for measuring and calculating a full life cycle carbon emission equivalent of a power battery, comprising: a first carbon emission equivalent acquisition module for acquiring a first carbon emission equivalent of a raw material acquisition stage of the power battery; a second carbon emission equivalent acquisition module for acquiring a second carbon emission equivalent of a production stage of the power battery; a third carbon emission equivalent acquisition module for acquiring a third carbon emission equivalent of a usage stage of the power battery; a fourth carbon emission equivalent acquisition module for acquiring a fourth carbon emission equivalent of a cascading utilization stage and a regeneration stage of the power battery; a full life cycle carbon emission equivalent acquisition module of the power battery for measuring and calculating the full life cycle carbon emission equivalent of the power battery based on the first carbon emission equivalent, the second carbon emission equivalent, the third carbon emission equivalent, and the fourth carbon emission equivalent.

The beneficial effect of the present disclosure is that: the method for measuring and calculating a full life cycle carbon emission equivalent of a power battery of the present disclosure collects the carbon emission equivalent in each link of the power battery life cycle, obtains the full life cycle carbon emission value, and considers the impact of manufacturing and regeneration process route on carbon emission, on the one hand, it covers relatively comprehensive content, on the other hand, it is closer to the actual process, and the calculated data is more reliable.

The method of the present disclosure has other features and advantages which will be apparent from the accompanying drawings and subsequent specific embodiments incorporated herein, or will be described in detail in the accompanying drawings and subsequent specific embodiments, which together serve to explain specific principles of the present invention.

### BRIEF DESCRIPTION OF THE DRAWINGS

By providing a more detailed description of exemplary embodiments of the present disclosure in conjunction with the accompanying drawings, the aforementioned and other objects, features, and advantages of the present disclosure will become more apparent. Among them, in exemplary embodiments of the present disclosure, the same reference numerals typically represent the same components.

FIG. 1 shows a flowchart of a method for measuring and calculating a full life cycle carbon emission equivalent of a power battery according to an embodiment of the present disclosure.

FIG. 2 shows a block diagram of an apparatus for measuring and calculating a full life cycle carbon emission equivalent of a power battery according to an embodiment of the present disclosure.

### REFERENCE NUMBERS

102. first carbon emission equivalent acquisition module; 104. second carbon emission equivalent acquisition module; 106. third carbon emission equivalent acquisition module; 108. fourth carbon emission equivalent acquisition module; 110. full life cycle carbon emission equivalent acquisition module of power battery.

### DESCRIPTION OF THE EMBODIMENTS

According to the present disclosure, a method for measuring and calculating a full life cycle carbon emission equivalent of a power battery, comprising: acquiring a first carbon emission equivalent of a raw material acquisition stage of a power battery; acquiring a second carbon emission equivalent of a production stage of the power battery; acquiring a third carbon emission equivalent of a usage stage of the power battery; acquiring a fourth carbon emission equivalent of a cascading utilization stage and a regeneration stage of the power battery; measuring and calculating the full life cycle carbon emission equivalent of the power battery on the basis of the first carbon emission equivalent, the second carbon emission equivalent, the third carbon emission equivalent, and the fourth carbon emission equivalent.

Specifically, according to the characteristics of each stage of the full life cycle of the power battery, the carbon emission equivalent Em of the full life cycle of the battery is divided into the carbon emission equivalent of the raw material acquisition stage Em1 (the first carbon emission equivalent), the carbon emission equivalent of the power battery production stage Em2 (the second carbon emission equivalent), the carbon emission equivalent of the use stage Em3 (the third carbon emission equivalent), and the carbon emission equivalent of the reuse and regeneration stage Em4 (the fourth carbon emission equivalent), the full life cycle carbon emission equivalent of the power battery Em=Em1+Em2+Em3+Em4.

According to an exemplary implementation, the method for measuring and calculating a full life cycle carbon emission equivalent of a power battery collects the carbon emission equivalents in each link of the full life cycle of the power battery, obtains the full life cycle carbon emission value, and takes into account the impact of production and regeneration process routes on carbon emission, on the one hand, it covers a relatively comprehensive content; on the other hand, it is closer to the actual process, and the calculated data is more reliable.

As a preferred solution, the first carbon emission equivalent is calculated by the following formula:

$$Em 1 = \sum ECm 1 i * k 1 i + \sum Tm 1 i * k 2 i \qquad ( 2 )$$

wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

Specifically, the method for calculating the carbon emission equivalent of the raw material acquisition stage Em1 is as follows:

$$Em 1 = \sum ECm 1 i * k 1 i + \sum Tm 1 i * k 2 i \qquad ( 2 )$$

wherein i=1, 2, 3, . . . , N, and N represents the number of raw material types; ECm1 is an energy consumption value of the raw material acquisition stage, kwh; k1 is a carbon emission equivalent coefficient of using 1 kilowatt-hour of electricity at the raw material acquisition stage; Tm1 is an energy consumption value of the transportation link at the raw material acquisition stage; k2 is a carbon emission equivalent coefficient of using 1 kilowatt-hour of electricity in the raw material transportation link.

As a preferred solution, the second carbon emission equivalent is acquired by the following steps: according to a process flow, the production stage of the power battery is divided into an electrode preparation stage, an assembly stage, a formation and grading stage, a grouping stage, and an integration stage; acquiring carbon emission equivalents of the electrode preparation stage, the assembly stage, the formation and grading stage, the grouping stage, and the integration stage respectively; acquiring the second carbon emission equivalent based on the carbon emission equivalents of the electrode preparation stage, the assembly stage, the formation and grading stage, the grouping stage, the integration stage and a carbon emission equivalent produced in transportation.

As a preferred solution, the second carbon emission equivalent is calculated by the following formula:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value in the formation and grading stage; EMm2 is an energy consumption value of the grouping stage; ENm2 is an energy consumption value in the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

Specifically, firstly a production process is set up to calculate the carbon emission equivalent of the production stage of the power battery, the production stage is divided into an electrode preparation stage, an assembly stage, a formation and grading stage, a grouping stage, and an integration stage according to a process flow, the carbon emission equivalent of the production stage Em2 is calculated as follows:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein i=1, 2, 3, . . . , N, N represents the number of raw material types; EDm2 is an energy consumption value of the electrode preparation stage in production of the power battery, kwh; EFm2 is an energy consumption value of the assembly stage in production of the power battery, kwh; ELm2 is an energy consumption value of the formation stage in production of the power battery, kwh; EMm2 is an energy consumption value of the grouping stage in production of the power battery, kwh; ENm2 is an energy consumption value of the integration stage in production of the power battery, kwh; k3 is a carbon emission equivalent coefficient of using 1 kilowatt-hour of electricity in the production of the power battery; Tm2 is an energy consumption value in transportation after the production of the power battery is completed; k4 is a carbon emission equivalent coefficient of 1 kilowatt-hour of electricity in transportation after the production of the power battery.

As a preferred solution, the third carbon emission equivalent is calculated by the following formula:

$$Em 3 = EKm 3 * k 5$$

wherein Em3 is the third carbon emission equivalent, EKm3 is an energy consumption value in usage of the power battery; k5 is a carbon emission equivalent coefficient of 1 kilowatt-hour of electricity in usage of the power battery.

Specifically, acquisition of the carbon emission equivalent of a usage stage mainly relates to energy consumption during the charging and discharging process in usage, and the method for calculating the carbon emission equivalent of this stage is as follows:

$$Em 3 = EKm 3 * k 5 \qquad ( 4 )$$

wherein EKm3 is an energy consumption value in usage of the power battery, kwh; k5 is a carbon emission equivalent coefficient of 1 kilowatt-hour of electricity in usage of the power battery.

As a preferred solution, the fourth carbon emission equivalent is calculated by the following formula:

$$Em 4 = EPm 4 * k 6 + ETm 4 * k 7 + Tm 3 * k 8$$

wherein Em4 is the fourth carbon emission equivalent, EPm4 is an energy consumption value of the cascading utilization stage of the power battery; k6 is a carbon emission equivalent coefficient of using 1 kilowatt-hour of electricity of the cascading utilization of the power battery; ETm4 is an energy consumption value of the regeneration stage of the power battery; k7 is a carbon emission equivalent coefficient of using 1 kilowatt-hour of electricity of regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

Specifically, the acquisition of the carbon emission at the cascading utilization and regeneration stage mainly involves two parts: the cascading utilization stage and the regeneration stage, and the method for calculating the carbon emission equivalent of the cascading utilization and regeneration stage Em4 is as follows:

$$Em 4 = EPm 4 * k 6 + ETm 4 * k 7 + Tm 3 * k 8 \qquad ( 5 )$$

wherein EPm4 is an energy consumption value of the cascading utilization stage of the power battery, kwh; k6 is a carbon emission equivalent coefficient of using 1 kilowatt-hour of electricity of the cascading utilization stage of the power battery; ETm4 is an energy consumption value of the regeneration stage of the power battery, kwh; k7 is a carbon emission equivalent coefficient of using 1 kilowatt-hour of electricity of regeneration of the power battery; Tm3 is an energy consumption value of transportation at the cascading utilization and the regeneration stage of the power battery, kwh; k8 is a carbon emission equivalent coefficient of using 1 kilowatt-hour of electricity in transportation of the cascading utilization and the regeneration of the power battery.

The above carbon emission equivalent coefficients of 1 kilowatt-hour of electricity in various places can be obtained by querying the relevant tables.

As a preferred solution, the full life cycle carbon emission equivalent of the power battery is calculated by the following formula:

$$Em = Em 1 + Em 2 + Em 3 + Em 4$$

wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

The present disclosure also provides an electronic equipment, wherein the electronic equipment comprising: a memory, storing executable instructions; a processor, the processor runs the executable instructions in the memory, so as to realize the method for measuring and calculating a full life cycle carbon emission equivalent of a power battery.

The present disclosure also provides a computer readable storage medium, wherein the computer-readable storage medium stores a computer program, and when the computer program is executed by a processor, the method for measuring and calculating a full life cycle carbon emission equivalent of a power battery is realized.

The present disclosure also provides an apparatus for measuring and calculating a full life cycle carbon emission equivalent of a power battery, comprising: a first carbon emission equivalent acquisition module for acquiring a first carbon emission equivalent of a raw material acquisition stage of the power battery; a second carbon emission equivalent acquisition module for acquiring a second carbon emission equivalent of a production stage of the power battery; a third carbon emission equivalent acquisition module for acquiring a third carbon emission equivalent of a usage stage of the power battery; a fourth carbon emission equivalent acquisition module for acquiring a fourth carbon emission equivalent of a cascading utilization stage and a regeneration stage of the power battery; a full life cycle carbon emission equivalent acquisition module of the power battery for measuring and calculating the full life cycle carbon emission equivalent of the power battery based on the first carbon emission equivalent, the second carbon emission equivalent, the third carbon emission equivalent, and the fourth carbon emission equivalent.

Specifically, according to the characteristics of each stage of the full life cycle of the power battery, the carbon emission equivalent Em of the full life cycle of the battery is divided into the carbon emission equivalent of the raw material acquisition stage Em1 (the first carbon emission equivalent), the carbon emission equivalent of the power battery production stage Em2 (the second carbon emission equivalent), the carbon emission equivalent of the use stage Em3 (the third carbon emission equivalent), and the carbon emission equivalent of the reuse and regeneration stage Em4 (the fourth carbon emission equivalent), the full life cycle carbon emission equivalent of the power battery Em=Em1+Em2+Em3+Em4.

According to an exemplary implementation, the apparatus for measuring and calculating a full life cycle carbon emission equivalent of a power battery collects the carbon emission equivalents in each link of the full life cycle of the power battery, obtains the full life cycle carbon emission value, and takes into account the impact of production and regeneration process routes on carbon emission, on the one hand, it covers a relatively comprehensive content; on the other hand, it is closer to the actual process, and the calculated data is more reliable.

As a preferred solution, the first carbon emission equivalent is calculated by the following formula:

$$Em 1 = \sum ECm 1 i * k 1 i + \sum Tm 1 i * k 2 i \qquad ( 2 )$$

wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

Specifically, the method for calculating the carbon emission equivalent of the raw material acquisition stage Em1 is as follows:

$$Em 1 = \sum ECm 1 i * k 1 i + \sum Tm 1 i * k 2 i$$

wherein i=1, 2, 3, . . . , N, and N represents the number of raw material types; ECm1 is an energy consumption value of the raw material acquisition stage, kwh; k1 is a carbon emission equivalent coefficient of using 1 kilowatt-hour of electricity at the raw material acquisition stage; Tm1 is an energy consumption value of the transportation link at the raw material acquisition stage, hwh; k2 is a carbon emission equivalent coefficient of using 1 kilowatt-hour of electricity in the raw material transportation link.

As a preferred solution, the second carbon emission equivalent is acquired by the following steps: according to a process flow, the production stage of the power battery is divided into an electrode preparation stage, an assembly stage, a formation and grading stage, a grouping stage, and an integration stage; acquiring carbon emission equivalents of the electrode preparation stage, the assembly stage, the formation and grading stage, the grouping stage, and the integration stage respectively; acquiring the second carbon emission equivalent based on the carbon emission equivalents of the electrode preparation stage, the assembly stage, the formation and grading stage, the grouping stage, the integration stage and a carbon emission equivalent produced in transportation.

As a preferred solution, the second carbon emission equivalent is calculated by the following formula:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value in the formation and grading stage; EMm2 is an energy consumption value of the grouping stage; ENm2 is an energy consumption value in the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

Specifically, firstly a production process is set up to calculate the carbon emission equivalent of the production stage of the power battery, the production stage is divided into an electrode preparation stage, an assembly stage, a formation and grading stage, a grouping stage, and an integration stage according to a process flow, the carbon emission equivalent of the production stage Em2 is calculated as follows:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein i=1, 2, 3, . . . , N, N represents the number of raw material types; EDm2 is an energy consumption value of the electrode preparation stage in production of the power battery, kwh; EFm2 is an energy consumption value of the assembly stage in production of the power battery, kwh; ELm2 is an energy consumption value of the formation stage in production of the power battery, kwh; EMm2 is an energy consumption value of the grouping stage in production of the power battery, kwh; ENm2 is an energy consumption value of the integration stage in production of the power battery, kwh; k3 is a carbon emission equivalent coefficient of using 1 kilowatt-hour of electricity in the production of the power battery; Tm2 is an energy consumption value in transportation after the production of the power battery is completed; k4 is a carbon emission equivalent coefficient of 1 kilowatt-hour of electricity in transportation after the production of the power battery.

As a preferred solution, the third carbon emission equivalent is calculated by the following formula:

$$Em 3 = EKm 3 * k 5$$

wherein Em3 is the third carbon emission equivalent, EKm3 is an energy consumption value in usage of the power battery; k5 is a carbon emission equivalent coefficient of 1 kilowatt-hour of electricity in usage of the power battery.

Specifically, acquisition of the carbon emission equivalent of a usage stage mainly relates to energy consumption during the charging and discharging process in usage, and the method for calculating the carbon emission equivalent of this stage is as follows:

$$Em 3 = EKm 3 * k 5 \qquad ( 4 )$$

wherein EKm3 is an energy consumption value in usage of the power battery, kwh; k5 is a carbon emission equivalent coefficient of 1 kilowatt-hour of electricity in usage of the power battery.

As a preferred solution, the fourth carbon emission equivalent is calculated by the following formula:

$$Em 4 = EPm 4 * k 6 + ETm 4 * k 7 + Tm 3 * k 8$$

wherein Em4 is the fourth carbon emission equivalent, EPm4 is an energy consumption value of the cascading utilization stage of the power battery; k6 is a carbon emission equivalent coefficient of using 1 kilowatt-hour of electricity of the cascading utilization of the power battery; ETm4 is an energy consumption value of the regeneration stage of the power battery; k7 is a carbon emission equivalent coefficient of using 1 kilowatt-hour of electricity of regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

Specifically, the acquisition of the carbon emission at the cascading utilization and regeneration stage mainly involves two parts: the cascading utilization stage and the regeneration stage, and the method for calculating the carbon emission equivalent of the cascading utilization and regeneration stage Em4 is as follows:

$$Em 4 = EPm 4 * k 6 + ETm 4 * k 7 + Tm 3 * k 8 \qquad ( 5 )$$

wherein EPm4 is an energy consumption value of the cascading utilization stage of the power battery, kwh; k6 is a carbon emission equivalent coefficient of using 1 kilowatt-hour of electricity of the cascading utilization stage of the power battery; ETm4 is an energy consumption value of the regeneration stage of the power battery, kwh; k7 is a carbon emission equivalent coefficient of using 1 kilowatt-hour of electricity of regeneration of the power battery; Tm3 is an energy consumption value of transportation at the cascading utilization and the regeneration stage of the power battery, kwh; k8 is a carbon emission equivalent coefficient of using 1 kilowatt-hour of electricity in transportation of the cascading utilization and the regeneration of the power battery.

The above carbon emission equivalent coefficients of 1 kilowatt-hour of electricity in various places can be obtained by querying the relevant tables.

As a preferred solution, the full life cycle carbon emission equivalent of the power battery is calculated by the following formula:

$$Em = Em 1 + Em 2 + Em 3 + Em 4$$

wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

### Embodiment 1

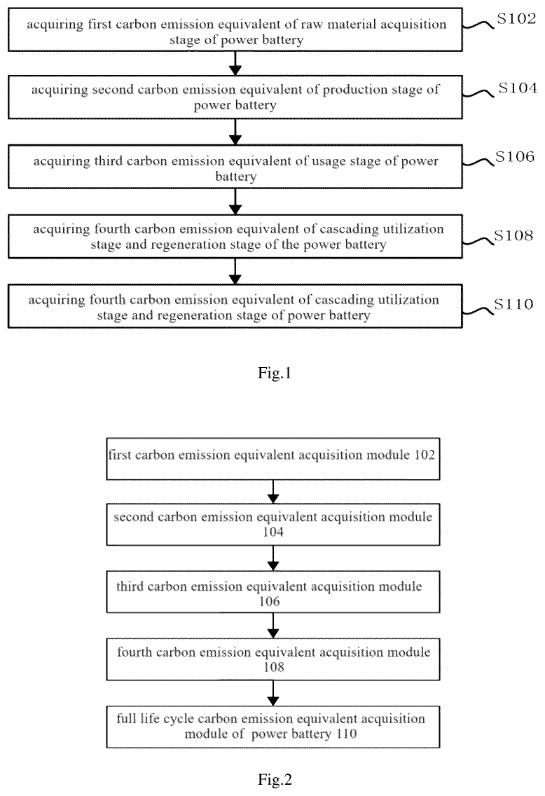

FIG. 1 shows a flowchart of a method for measuring and calculating a full life cycle carbon emission equivalent of a power battery according to an embodiment of the present disclosure.

As illustrated in FIG. 1, the method for measuring and calculating a full life cycle carbon emission equivalent of a power battery, comprising:

S102: Acquiring a first carbon emission equivalent of a raw material acquisition stage of a power battery.

The first carbon emission equivalent is calculated by the following formula:

$$Em 1 = \sum ECm 1 i * k 1 i + \sum Tm 1 i * k 2 i \qquad ( 2 )$$

wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

S104: Acquiring a second carbon emission equivalent of a production stage of the power battery.

The second carbon emission equivalent is acquired by the following steps: according to a process flow, the production stage of the power battery is divided into an electrode preparation stage, an assembly stage, a formation and grading stage, a grouping stage, and an integration stage; acquiring carbon emission equivalents of the electrode preparation stage, the assembly stage, the formation and grading stage, the grouping stage, and the integration stage respectively; acquiring the second carbon emission equivalent based on the carbon emission equivalents of the electrode preparation stage, the assembly stage, the formation and grading stage, the grouping stage, the integration stage and a carbon emission equivalent produced in transportation.

The second carbon emission equivalent is calculated by the following formula:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value in the formation and grading stage; EMm2 is an energy consumption value of the grouping stage; ENm2 is an energy consumption value in the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

S106: Acquiring a third carbon emission equivalent of a usage stage of the power battery.

The third carbon emission equivalent is calculated by the following formula:

$$Em 3 = EKm 3 * k 5$$

wherein Em3 is the third carbon emission equivalent, EKm3 is an energy consumption value in usage of the power battery; k5 is a carbon emission equivalent coefficient of 1 kilowatt-hour of electricity in usage of the power battery.

S108: Acquiring a fourth carbon emission equivalent of a cascading utilization stage and a regeneration stage of the power battery.

The fourth carbon emission equivalent is calculated by the following formula:

$$Em 4 = EPm 4 * k 6 + ETm 4 * k 7 + Tm 3 * k 8$$

wherein Em4 is the fourth carbon emission equivalent, EPm4 is an energy consumption value of the cascading utilization stage of the power battery; k6 is a carbon emission equivalent coefficient of using 1 kilowatt-hour of electricity of the cascading utilization of the power battery; ETm4 is an energy consumption value of the regeneration stage of the power battery; k7 is a carbon emission equivalent coefficient of using 1 kilowatt-hour of electricity of regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

S110: Measuring and calculating the full life cycle carbon emission equivalent of the power battery on the basis of the first carbon emission equivalent, the second carbon emission equivalent, the third carbon emission equivalent, and the fourth carbon emission equivalent.

The full life cycle carbon emission equivalent of the power battery is calculated by the following formula:

$$Em = Em 1 + Em 2 + Em 3 + Em 4$$

wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

### Embodiment 2

FIG. 2 shows a block diagram of an apparatus for measuring and calculating a full life cycle carbon emission equivalent of a power battery according to an embodiment of the present disclosure.

As illustrated in FIG. 2, the apparatus for measuring and calculating a full life cycle carbon emission equivalent of a power battery, comprising:
a first carbon emission equivalent acquisition module 102 for acquiring a first carbon emission equivalent of a raw material acquisition stage of the power battery.

The first carbon emission equivalent is calculated by the following formula:

$$Em 1 = \sum ECm 1 i * k 1 i + \sum Tm 1 i * k 2 i \qquad ( 2 )$$

wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

A second carbon emission equivalent acquisition module 104 for acquiring a second carbon emission equivalent of a production stage of the power battery.

The second carbon emission equivalent is acquired by the following steps: according to a process flow, the production stage of the power battery is divided into an electrode preparation stage, an assembly stage, a formation and grading stage, a grouping stage, and an integration stage; acquiring carbon emission equivalents of the electrode preparation stage, the assembly stage, the formation and grading stage, the grouping stage, and the integration stage respectively; acquiring the second carbon emission equivalent based on the carbon emission equivalents of the electrode preparation stage, the assembly stage, the formation and grading stage, the grouping stage, the integration stage and a carbon emission equivalent produced in transportation.

The second carbon emission equivalent is calculated by the following formula:

$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$

wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value in the formation and grading stage; EMm2 is an energy consumption value of the grouping stage; ENm2 is an energy consumption value in the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

A third carbon emission equivalent acquisition module 106 for acquiring a third carbon emission equivalent of a usage stage of the power battery.

The third carbon emission equivalent is calculated by the following formula:

$$Em 3 = EKm 3 * k 5$$

wherein Em3 is the third carbon emission equivalent, EKm3 is an energy consumption value in usage of the power battery; k5 is a carbon emission equivalent coefficient of 1 kilowatt-hour of electricity in usage of the power battery.

A fourth carbon emission equivalent acquisition module 108 for acquiring a fourth carbon emission equivalent of a cascading utilization stage and a regeneration stage of the power battery.

The fourth carbon emission equivalent is calculated by the following formula:

$$Em 4 = EPm 4 * k 6 + ETm 4 * k 7 + Tm 3 * k 8$$

wherein Em4 is the fourth carbon emission equivalent, EPm4 is an energy consumption value of the cascading utilization stage of the power battery; k6 is a carbon emission equivalent coefficient of using 1 kilowatt-hour of electricity of the cascading utilization of the power battery; ETm4 is an energy consumption value of the regeneration stage of the power battery; k7 is a carbon emission equivalent coefficient of using 1 kilowatt-hour of electricity of regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

A full life cycle carbon emission equivalent acquisition module 110 of the power battery for measuring and calculating the full life cycle carbon emission equivalent of the power battery based on the first carbon emission equivalent, the second carbon emission equivalent, the third carbon emission equivalent, and the fourth carbon emission equivalent.

The full life cycle carbon emission equivalent of the power battery is calculated by the following formula:

$$Em = Em 1 + Em 2 + Em 3 + Em 4$$

wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

### Embodiment 3

The present disclosure provides an electronic equipment, wherein the electronic equipment comprising: a memory, storing executable instructions; a processor, the processor runs the executable instructions in the memory, so as to realize the method for measuring and calculating a full life cycle carbon emission equivalent of a power battery.

The electronic equipment according to an embodiment of the present disclosure includes a memory and a processor.

The memory is used to store non-transitory computer readable instructions. Specifically, the memory may include one or more computer program products, which may include various forms of computer-readable storage media, such as volatile memory and/or non-volatile memory. The volatile memory may include, for example, random access memory (RAM) and/or cache memory (cache). The non-volatile memory may include, for example, a read-only memory (ROM), a hard disk, a flash memory, and the like.

The processor may be a central processing unit (CPU) or other form of processing unit having data processing capabilities and/or instruction execution capabilities, and may control other components in the electronic equipment to perform desired functions. In one embodiment of the present disclosure, the processor is configured to execute the computer readable instructions stored in the memory.

Those skilled in the art should understand that in order to solve the technical problem of how to obtain a good user experience effect, this embodiment may also include known structures such as communication buses and interfaces, and these known structures should also be included in the protection scope of the present disclosure within.

For detailed descriptions of this embodiment, reference may be made to corresponding descriptions in the preceding embodiments, and details are not repeated here.

### Embodiment 4

The present disclosure provides a computer readable storage medium, wherein the computer-readable storage medium stores a computer program, and when the computer program is executed by a processor, the method for measuring and calculating a full life cycle carbon emission equivalent of a power battery is realized.

A computer-readable storage medium according to an embodiment of the present disclosure has non-transitory computer-readable instructions stored thereon. When the non-transitory computer-readable instructions are executed by the processor, all or part of the steps of the aforementioned methods in the various embodiments of the present disclosure are executed.

The above-mentioned computer-readable storage media include but are not limited to: optical storage media (for example, CD-ROM and DVD), magneto-optical storage media (for example, MO), magnetic storage media (for example, magnetic tape or mobile hard disk), media with built-in rewritable non-volatile memory (for example, memory card) and media with built-in ROM (for example, ROM cartridge).

While embodiments of the present disclosure have been described above, the foregoing description is exemplary, not exhaustive, and is not limited to the disclosed embodiments. Many modifications and alterations will be apparent to those of ordinary skill in the art without departing from the scope and spirit of the described embodiments.

1. A method for measuring and calculating a full life cycle carbon emission equivalent of a power battery, comprising:
acquiring a first carbon emission equivalent of a raw material acquisition stage of a power battery;
acquiring a second carbon emission equivalent of a production stage of the power battery;
acquiring a third carbon emission equivalent of a usage stage of the power battery;
acquiring a fourth carbon emission equivalent of a cascading utilization stage and a regeneration stage of the power battery;
measuring and calculating the full life cycle carbon emission equivalent of the power battery on the basis of the first carbon emission equivalent, the second carbon emission equivalent, the third carbon emission equivalent, and the fourth carbon emission equivalent.

2. The method for measuring and calculating a full life cycle carbon emission equivalent of a power battery according to claim 1, wherein the first carbon emission equivalent is calculated by the following formula:
$$Em 1 = \sum ECm 1 i * k 1 i + \sum Tm 1 i * k 2 i \qquad ( 2 )$$
wherein Em1 is the first carbon emission equivalent, ECm1i is an energy consumption value of an i-th raw material acquisition stage; k1i is a carbon emission equivalent coefficient of using 1 kilowatt-hour of electricity at the i-th raw material acquisition stage; Tm1i is an energy consumption value of an i-th raw material transportation link; k2i is a carbon emission equivalent coefficient of using 1 kilowatt-hour of electricity in the i-th raw material transportation link, i=1, 2, 3, . . . , N, and N represents the number of raw material types.

3. The method for measuring and calculating a full life cycle carbon emission equivalent of a power battery according to claim 1, wherein the second carbon emission equivalent is acquired by the following steps:
according to a process flow, the production stage of the power battery is divided into an electrode preparation stage, an assembly stage, a formation and grading stage, a grouping stage, and an integration stage;
acquiring carbon emission equivalents of the electrode preparation stage, the assembly stage, the formation and grading stage, the grouping stage, and the integration stage respectively;
acquiring the second carbon emission equivalent based on the carbon emission equivalents of the electrode preparation stage, the assembly stage, the formation and grading stage, the grouping stage, the integration stage and a carbon emission equivalent produced in transportation.

4. The method for measuring and calculating a full life cycle carbon emission equivalent of a power battery according to claim 3, wherein the second carbon emission equivalent is calculated by the following formula:
$$Em 2 = ( \sum EDm 2 i + \sum EFm 2 + \sum ELm 2 + \sum EMm 2 + \sum ENm 2 ) * k 3 + Tm 2 * k 4 \qquad ( 3 )$$
wherein Em2 is the second carbon emission equivalent; EDm2i is an energy consumption value when the i-th raw material is subjected to the electrode preparation stage in production of the power battery, i=1, 2, 3, . . . , N, N represents the number of raw material types; EFm2 is an energy consumption value of the assembly stage, ELm2 is an energy consumption value of the formation and grading stage; EMm2 is an energy consumption value of the grouping stage; ENm2 is an energy consumption value of the integration stage; k3 is a carbon emission equivalent coefficient of using 1 kilowatt-hour of electricity in the production of the power battery; Tm2 is an energy consumption value in transportation of the power battery; k4 is a carbon emission equivalent coefficient of using 1 kilowatt-hour of electricity in transportation of the power battery.

5. The method for measuring and calculating a full life cycle carbon emission equivalent of a power battery according to claim 1, wherein the third carbon emission equivalent is calculated by the following formula:
$$Em 3 = EKm 3 * k 5$$
wherein Em3 is the third carbon emission equivalent, EKm3 is an energy consumption value in usage of the power battery; k5 is a carbon emission equivalent coefficient of 1 kilowatt-hour of electricity in usage of the power battery.

6. The method for measuring and calculating a full life cycle carbon emission equivalent of a power battery according to claim 1, wherein the fourth carbon emission equivalent is calculated by the following formula:
$$Em 4 = EPm 4 * k 6 + ETm 4 * k 7 + Tm 3 * k 8$$
wherein Em4 is the fourth carbon emission equivalent, EPm4 is an energy consumption value of the cascading utilization stage of the power battery; k6 is a carbon emission equivalent coefficient of using 1 kilowatt-hour of electricity in cascading utilization of the power battery; ETm4 is an energy consumption value of the regeneration stage of the power battery; k7 is a carbon emission equivalent coefficient of using 1 kilowatt-hour of electricity in regeneration of the power battery; Tm3 is an energy consumption value of transportation at the cascading utilization stage and the regeneration stage of the power battery; k8 is a carbon emission equivalent coefficient of using 1 kilowatt-hour of electricity in transportation at the cascading utilization stage and the regeneration stage of the power battery.

7. The method for measuring and calculating a full life cycle carbon emission equivalent of a power battery according to claim 1, wherein the full life cycle carbon emission equivalent of the power battery is calculated by the following formula:
$$Em = Em 1 + Em 2 + Em 3 + Em 4$$
wherein Em is the full life cycle carbon emission equivalent of the power battery, Em1 is the first carbon emission equivalent, Em2 is the second carbon emission equivalent, Em3 is the third carbon emission equivalent, and Em4 is the fourth carbon emission equivalent.

8. An electronic equipment, wherein the electronic equipment comprising:
a memory, storing executable instructions;
a processor, the processor runs the executable instructions in the memory, so as to realize the method for measuring and calculating a full life cycle carbon emission equivalent of a power battery claim 1.

9. (canceled)

10. An apparatus for measuring and calculating a full life cycle carbon emission equivalent of a power battery, comprising:
a first carbon emission equivalent acquisition module for acquiring a first carbon emission equivalent of a raw material acquisition stage of the power battery;
a second carbon emission equivalent acquisition module for acquiring a second carbon emission equivalent of a production stage of the power battery;
a third carbon emission equivalent acquisition module for acquiring a third carbon emission equivalent of a usage stage of the power battery;
a fourth carbon emission equivalent acquisition module for acquiring a fourth carbon emission equivalent of a cascading utilization stage and a regeneration stage of the power battery;
a full life cycle carbon emission equivalent acquisition module of the power battery for measuring and calculating the full life cycle carbon emission equivalent of the power battery based on the first carbon emission equivalent, the second carbon emission equivalent, the third carbon emission equivalent, and the fourth carbon emission equivalent.
